(19) United States
(12) Patent Application Publication
(10) Pub. No.: US 2008/0125138 A1
(43) Pub. Date: May 29, 2008

(54) DATA CALL CONTROL METHOD AND APPARATUS FOR MOBILE STATION

(75) Inventors: Yo Seob KWAK, Suwon-si (KR); Jeong-Hyo YI, Suwon-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/829,399

(22) Filed: Jul. 27, 2007

(30) Foreign Application Priority Data
Nov. 23, 2006 (KR) 10-2006-0116331

(51) Int. Cl. H04Q 7/20

(52) U.S. Cl. 455/453

(57) ABSTRACT

A data call control method for a mobile station includes detecting reception of a Release order message from a corresponding base station during a data call for a service option, determining if call retry restriction is necessary on the basis of the received Release order message, and restricting, if call retry restriction is necessary, retrying of the data call for the service option for a retry delay period. A device that implements such methods includes a radio frequency unit and a control unit to restrict retrial of a data call during the data call delay period.

### CROSS REFERENCE TO RELATED APPLICATION

This application claims priority from and the benefit of Korean Patent Application No. 10-2006-0116331, filed Nov. 23, 2006, which is hereby incorporated by reference for all purposes as if fully set forth herein.

### BACKGROUND OF THE INVENTION

1. Field of the Invention

The present invention relates to a mobile station supporting packet data services and, more particularly, to a data call control method and apparatus for a mobile station, wherein when the mobile station receives a Release order message during a data call for a particular data service, retrying the data call for the same data service is restricted, which may maintain network efficiency.

2. Discussion of the Background

Advanced mobile communication systems provide both voice services and high-speed data services to users through wireless channels. Efficient management of wireless channel resources is necessary for a mobile communication system to provide data services such as packet data services. For example, static allocation of a traffic channel to a data service results in the waste of wireless channel resources.

FIG. 1 is a sequence diagram showing interactions between a mobile station and a base station to establish a data service connection.

Referring to FIG. 1, the mobile station 100 transmits an Origination message requesting a particular service option to the base station 150 (S101). In response to the Origination message, the base station 150 allocates a traffic channel and transmits a Channel assignment message indicating the allocated traffic channel to the mobile station 100. When the mobile station 100 receives the Channel assignment message, the traffic channel is established (S103).

Thereafter, the mobile station 100 and the base station 150 perform service negotiation with each other. The base station 150 transmits a Service connect message to the mobile station 100 (S105). In return, the mobile station 100 transmits a Service connect completion message to the base station 150 (S107).

After service negotiation, the mobile station 100 and base station 150 negotiate with each other to establish a Point-to-Point protocol (PPP) session (S109). Thereby, a data call is established between the mobile station 100 and base station 150, and packet data may be exchanged through the data call.

When the mobile station 100 in a data service receives a Release order message from the base station 150, it releases the allocated traffic channel. In particular, when the mobile station 100 receives a Release order message before a data call is established, the mobile station 100 releases the traffic channel. In addition, it should not retry to place a data call for the same data service. However, conventional mobile stations may not be able to restrict a data call retrial, resulting in wasted wireless resources and reduced network efficiency.

### SUMMARY OF THE INVENTION

The present invention provides a method and apparatus for a mobile station that may restrict retrial of a data call.

The present invention also provides a method and apparatus for a mobile station that restrict retrial of a data call for the same data service when the mobile station receives a Release order message during a data call for a particular data service.

Additional features of the invention will be set forth in the description which follows, and in part will be apparent from the description, or may be learned by practice of the invention.

The present invention discloses method for controlling a data call at a mobile station, including detecting reception of a Release order message from a base station during a data call, determining whether call retry restriction is necessary based on the Release order message, and restricting retrying of the data call during a retry delay period when call restriction is necessary.

The present invention also discloses a control method for controlling a data call at a mobile station, including receiving a Release order message from a corresponding base station during a data call for a service option, determining whether the service option is connected at the time of reception of the Release order message, releasing, if a traffic channel is allocated and the service option is not connected, the allocated traffic channel and terminating the data call, determining, if the service option is connected, whether packets to be transmitted are present, releasing, if a traffic channel is allocated and the service option is connected and packets to be transmitted are not present, the allocated traffic channel, and releasing, if a traffic channel is allocated and the service option is connected and packets to be transmitted are present, the allocated traffic channel and terminating the data call.

The present invention also discloses a data call control apparatus for a mobile station, including a radio frequency unit to perform voice and data communication with a base station and a control unit to restrict retrial of the data call for the service option for a retry delay period, upon reception of a Release order message from the base station during a data call.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a sequence diagram showing interactions between a mobile station and a base station to establish a data service connection.

FIG. 2 shows a configuration of a mobile station according to an exemplary embodiment of the present invention.

FIG. 3 is a flow chart showing a data call control method according to another exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

The present invention relates to data call retry restriction in a mobile station supporting data services. When the mobile station receives a Release order message from a serving base station during a data call for a particular data service, retrying the data call for the data service is restricted.

In particular, when the mobile station receives a Release order message from the base station within a specified time from traffic channel allocation to PPP negotiation (before allocation of Internet Protocol (IP)-related resources), it terminates the current data call and restricts a data call retry restriction is enforced. Consequently, the mobile station no longer transmits an Origination message requesting the same data service on an access channel during a retry delay period. This may prevent degradation of mobile network efficiency.

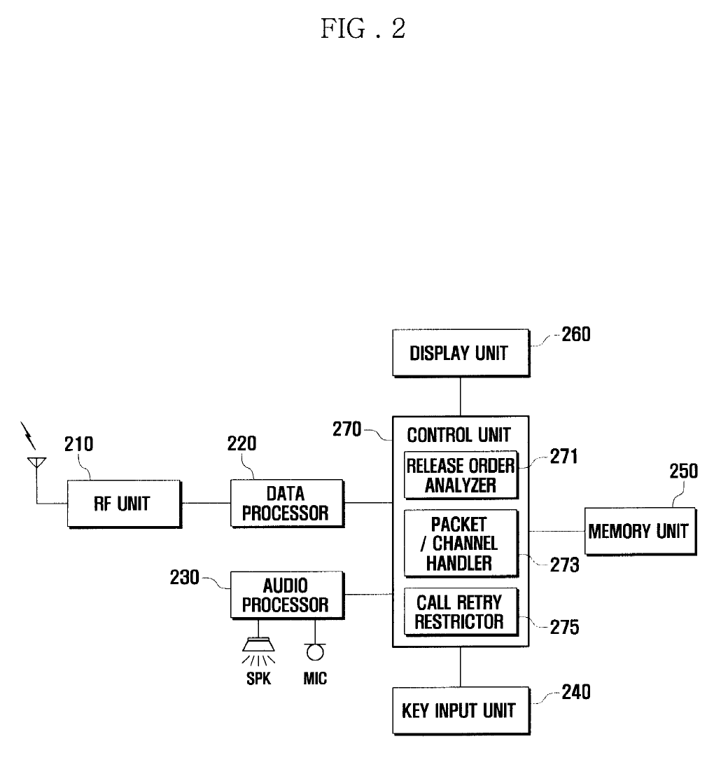

FIG. 2 shows a configuration of a mobile station according to an exemplary embodiment of the present invention.

Referring to FIG. 2, a mobile station supports voice and data communication through a wireless network and includes a radio frequency (RF) unit 210, a data processor 220, an audio processor 230, a key input unit 240, a memory unit 250, a display unit 260, and a control unit 270. The control unit 270 includes a release order analyzer 271, a packet/channel handler 273, and a call retry restrictor 275.

The RF unit 210 performs voice and data communications for the mobile station through a wireless channel to a mobile communication system. The RF unit 210 may include an RF transmitter for up-converting the frequency of a signal to be transmitted and amplifying the signal, and an RF receiver for low-noise amplifying a received signal and down-converting the frequency of the received signal.

The data processor 220 processes audio data that is transmitted to and from the audio processor 230, alphanumeric data from the key input unit 240, and voice data and other user data (for example, a Release order message and packet data related to a data service) that is transmitted to and from the RF unit 210. The data processor 220 may include an encoder/decoder (codec) and a modem to process signals transmitted through the RF unit 210. The codec includes a data codec to process packet data, and an audio codec to process audio data such as a voice signal.

The audio processor 230 reproduces an audio signal from the data processor 220 through a speaker SPK, and transmits an audio signal, such as a voice signal from a microphone MIC, to the data processor 220.

The key input unit 240 includes numeric, character, and function keys to input alphanumeric information and for setting various functions. The key input unit 240 transmits key signals for user settings and control of the mobile station to the control unit 270.

The memory unit 250 stores control and application programs related to the operation of the mobile station, as well as data resulting from execution of the application programs or data received from an external source (for example, a Release order message and packet data for a data service). The memory unit 250 may provide a plurality of buffers for storing temporary data resulting from execution of an application program.

The display unit 260 displays, under the control of the control unit 270, messages and status data related to operation of the mobile station. The display unit 260 may include a liquid crystal display (LCD) device. If the panel has touch screen capability, the display unit 260 may also act as an input device.

The control unit 270 controls the overall operation and signal exchange between internal elements of the mobile station, and may include the data processor 220. In particular, the control unit 270 restricts data call retrial when the mobile station receives a Release order message from a base station during a data call for a particular data service. For that purpose, the control unit 270 includes the release order analyzer 271, packet/channel handler 273, and call retry restrictor 275.

The release order analyzer 271 analyzes a Release order message received from a corresponding base station to determine the necessity of restrictions on data call retrial. For example, if a Release order message is received within a period of time from traffic channel allocation to PPP negotiation, the release order analyzer 271 determines that data call retry restriction is necessary.

If data call retry restriction is determined to be necessary, the packet/channel handler 273 terminates the current data call and releases the traffic channel allocated to the mobile station.

### Also, the call retry restrictor 275 restricts retrying of the data call so as to prevent the transmission of an Origination message requesting the same data service on an access channel during a retry delay period.

Referring to FIG. 2, the operation of the mobile station for data call retry restriction is described. When a Release order message is received from a corresponding base station, the release order analyzer 271 determines the necessity of data call retry restriction.

For example, if a Release order message is received within a time duration from traffic channel allocation to PPP negotiation, the release order analyzer 271 determines that data call retry restriction is necessary.

If data call retry restriction is necessary, the packet/channel handler 273 terminates the current data call and releases the traffic channel allocated to the mobile station. In addition, the call retry restrictor 275 restricts retries of a data call so as to prevent transmission of an Origination message requesting the same data service on an access channel for a retry delay duration.

The configuration in FIG. 2 is illustrated for the purpose of description. The present invention is not limited to the illustrated configuration. Therefore, the mobile station may further include modules such as a Bluetooth module, camera module, and digital broadcast receiving module.

Hereinabove, the configuration and operation of the mobile station are described. Next, a method of data call retry restriction is described. That is, if a Release order message is received while connecting a data call, retries of the data call is restricted for a preset time duration. The present invention is not limited to the following description, and many modifications may be made to the method.

The mobile station of the present invention may further include, among others, a Bluetooth module, camera module, or digital broadcast receiving module.

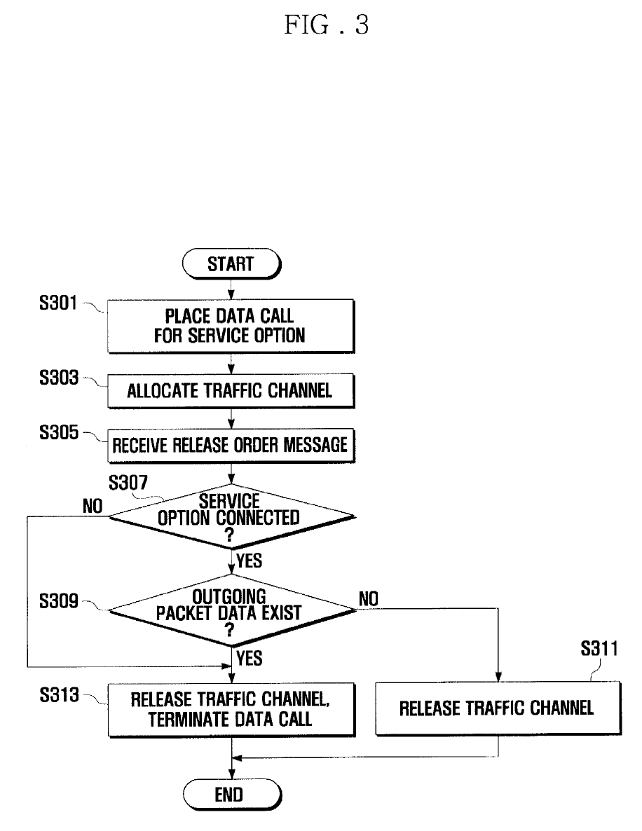

FIG. 3 is a flow chart showing a data call control method for a mobile station according to another exemplary embodiment of the present invention.

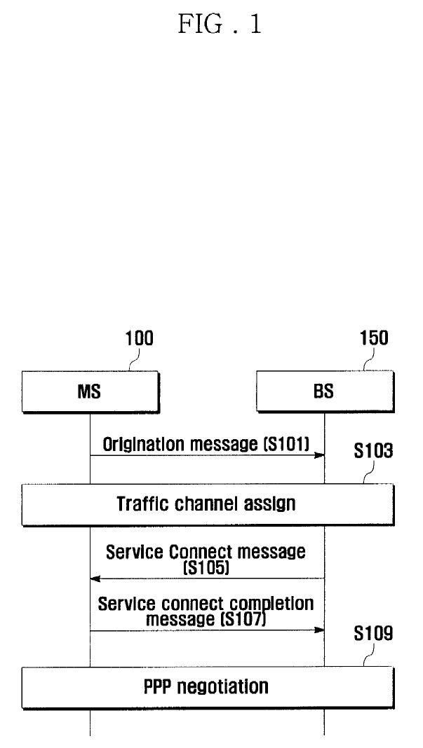

Referring to FIG. 3, the mobile station places a data call by sending an Origination message requesting a data service option to a corresponding base station (S301). In reply to the Origination message, the base station allocates a traffic channel to the mobile station (S303), as described in connection with FIG. 1.

When the mobile station receives a Release order message from the base station (S305), the mobile station determines whether the data service option is already connected (S307). If the data service option is not yet connected, the mobile station releases the traffic channel and terminates the current data call (S313).

If the data service option is already connected, the mobile station checks whether packets to be transmitted are present (S309). The packets may contain photographs or moving images.

If there are no packets to be transmitted, the mobile station releases the traffic channel and terminates the data call (S313). If packets to be transmitted are not present, the mobile station releases the traffic channel (S311).

As apparent from the above description, the present invention provides a data call control method and apparatus for a mobile station that restricts retrying the data call for the same data service when the mobile station receives a Release order message from a serving base station during a data call for a particular data service, so as not to transmit an Origination message. This may prevent degradation of mobile network efficiency.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method for controlling a data call at a mobile station, comprising:
detecting reception of a Release order message from a base station during a data call;
determining whether call retry restriction is necessary based on the Release order message; and restricting retrying of the data call f during a retry delay period, when call retry restriction is necessary.

2. The method of claim 1, wherein determining whether call retry restriction is necessary further comprises:
determining whether a traffic channel is allocated at the time of reception of the Release order message;
releasing, if a traffic channel is allocated, the allocated traffic channel;
determining, if a traffic channel is not allocated, whether the service option is connected;
performing, if the service option is not connected, traffic channel release and terminating the data call;
determining, if the service option is connected, whether packets to be transmitted are present;
performing, if packets to be transmitted are not present, traffic channel release; and performing, if packets to be transmitted are present, traffic channel release and terminating the data call.

3. The method of claim 1, wherein the call retry restriction is necessary when receiving the Release order message within a time period from traffic channel allocation to point-to-point protocol (PPP) session negotiation.

4. The method of claim 1, wherein restricting retrying of the data call comprises prohibiting the mobile station from transmitting an Origination message on an access channel to the base station during the retry delay period.

5. A data call control method for a mobile station, comprising:
receiving a Release order message from a corresponding base station during a data call for a particular service option;
determining whether a traffic channel is allocated at the time of reception of the Release order message;
releasing, if a traffic channel is allocated, the allocated traffic channel;
determining, if a traffic channel is not allocated, whether the service option is connected;
performing, if the service option is not connected, traffic channel release and terminating the data call;
determining, if the service option is connected, whether packets to be transmitted are present;
performing, if packets to be transmitted are not present, traffic channel release; and performing, if packets to be transmitted are present, traffic channel release and terminating the data call.

6. The data call control method of claim 5, wherein traffic channel release or data call termination is performed when the Release order message is received within a time duration from traffic channel allocation to point-to-point protocol (PPP) session negotiation.

7. The data call control method of claim 5, wherein the mobile station is prohibited from transmitting an Origination message on an access channel to the base station for a retry delay period after traffic channel release or data call termination.

8. A data call control apparatus for a mobile station, comprising:
a radio frequency unit to perform voice and data communication with a base station; and
a control unit to restrict retrying of a data call for the service option during a retry delay period upon reception of a Release order message from the base station during the data call.

9. The data call control apparatus of claim 8, wherein the control unit comprises:
a release order analyzer to analyze a received Release order message to determine if call retry restriction is necessary; and
a call retry restrictor to restrict, if call retry restriction is necessary, retrying of the data call for the service option.

10. The data call control apparatus of claim 9, wherein the control unit determines that call retry restriction is necessary when the Release order message is received within a time period from traffic channel allocation to point-to-point protocol (PPP) session negotiation.

11. The data call control apparatus of claim 9, wherein the control unit further comprises a packet/channel handler to release an allocated traffic channel and terminate the current data call.

12. The data call control apparatus of claim 9, wherein the call retry restrictor prohibits transmission of an Origination message on an access channel to the base station during the retry delay period after traffic channel release or data call termination if call retry restriction is determined to be necessary.

13. The data call control apparatus of claim 8, further comprising a data processor to process data associated with a received Release order message and packet data associated with a connected service option.
